(19) United States
(12) Patent Application Publication
(10) Pub. No.: US 2025/0234193 A1
(43) Pub. Date: Jul. 17, 2025

(54) AUTHENTICATING WIRELESS SENSOR NODES IN A NETWORK USING PHYSICAL PHENOMENON

(71) Applicant: TEXAS INSTRUMENTS INCORPORATED, Dallas, TX (US)

(72) Inventors: Shyam Krishnan Venkateswaran, Atlanta, GA (US); Ariton E. Xhafa, Plano, TX (US)

(21) Appl. No.: 18/415,644

(22) Filed: Jan. 17, 2024

(51) Int. Cl. H04W 12/06; B60L 58/10

(52) U.S. Cl. CPC H04W 12/06; B60L 58/10

(57) ABSTRACT

A battery management system (BMS) includes a battery pack including multiple battery cells and a first node configured to: cause one or more battery cells of the battery pack to alter a current or a voltage, receive a first value from a second node, compare the first value with a second value calculated based on the altered current or the altered voltage, and authenticate the second node as a member of the BMS based on comparing the first value with the second value.

### BACKGROUND

Modern vehicles may include multiple battery cells. Information associated with the cells, such as temperature, voltage, and other indicators of cell status and health, may be monitored for vehicular safety and to ensure proper operation. In a conventional wired battery management system, rechargeable batteries are managed by circuitry for the safe and efficient operation of the batteries. Wired communication interfaces can be used to connect a main microcontroller (the main node or master node) to each battery module (the secondary nodes), and each battery module is chained to the rest of the battery modules in a daisy chain. With wired communication interfaces, the main microcontroller cannot monitor and control all the battery modules in parallel without complex wiring. This wiring makes repair or replacement of individual battery cells more difficult, and importantly, adds weight and bulk to the overall system.

A wireless connection between the battery modules and the microcontroller makes management of battery modules more flexible and easier to repair. In a wireless battery management system (WBMS), a microcontroller monitors each battery module and communicates with the battery modules using wireless communication interfaces. The main microcontroller controls all the battery modules using a WBMS protocol. Wireless communication interfaces can suffer from wireless communication channel bandwidth variance, interference, and/or other issues, which would prevent proper monitoring and management in a WBMS.

### SUMMARY

Disclosed techniques facilitate authentication of nodes in wireless network without the need for a whitelist, such as nodes in a battery management system (BMS). The techniques include modifying a physical phenomenon, such as a voltage or current, and receiving a calculated value from an unauthenticated node to verify whether the unauthenticated node is able to observe the modified physical phenomenon, thereby demonstrating a connection to the physical phenomenon.

In some examples, a BMS includes a battery pack including multiple battery cells and a first node. The first node is configured to cause one or more battery cells of the battery pack to alter a current or a voltage, receive a first value from a second node, compare the first value with a second value calculated based on the altered current or the altered voltage, and authenticate the second node as a member of the BMS based on comparing the first value with the second value.

In other examples, a method for authenticating wireless nodes in a network by a first node in the network includes altering a physical phenomenon in a pattern known to the first node, receiving a first value from a second node, comparing the first value with a second value calculated based on the known pattern, and authenticating the second node as a member of the network based on comparing the first value with the second value.

In other examples, a method for a second node to be authenticated in a Wireless Battery Management System (WBMS) includes sampling a current or a voltage of a battery pack, calculating a first value based on the sampled current or the sampled voltage, sending the first value to a first node, and in response to sending the first value to the first node, receiving an indication of authentication as a member of the WBMS.

### BRIEF DESCRIPTION OF THE DRAWINGS

FIG. 1 is a block diagram of a WBMS according to various examples.

FIG. 2A is a block diagram of a WBMS according to various examples.

FIG. 2B is a block diagram of a WBMS according to various examples.

FIG. 3 is a sequence diagram showing interactions between a trusted node and an unauthenticated node for authenticating the unauthenticated node in a BMS according to various examples.

FIG. 4 is a flow diagram of a method for authenticating a node for a BMS according to various examples.

FIG. 5 is a flow diagram of a method by a node to be authenticated by a BMS according to various examples.

### DETAILED DESCRIPTION

Some electronic devices operate using batteries. For example, electric vehicles include multiple battery cells that provide power to those vehicles. Because battery cells in an electronic device can provide large amounts of power, and further because the power provided by the battery cells may be vital to the operation of the electronic device, the electronic device may include a system to manage the battery cells.

Battery management systems (BMSs) may manage the battery cells of an electronic device in various ways. For example, a BMS may monitor the health (e.g., voltage, current, temperature, pressure) of battery cells in an electronic device. Further, the BMS may control various battery cells to manage the quantity of power provided by the battery cells and where that power is directed within the electronic device. Generally, a BMS includes multiple components, such as multiple battery modules and a controller to manage the battery modules. Each battery module, in turn, may couple to multiple battery cells and include a battery monitor to monitor those battery cells. Thus, the battery cells coupled to a battery module provide power to the electronic device; the battery monitor in the battery module monitors the health and operation of the battery cells in that battery module; and the controller communicates with the battery monitor to ensure the battery module and its cells are operating properly. The controller may also communicate with the battery monitor to control the operation of the battery cells, such as to turn on, turn off, redirect, or otherwise balance the power provided by those battery cells.

BMSs may incorporate wireless technology. For example, a primary network node contains or is coupled to a controller and a secondary network node contains a battery module that controls multiple battery cells. The primary and secondary network nodes may communicate with each other wirelessly, for example using radio frequencies.

In some examples of this disclosure, a BMS includes a trusted node configured to initiate a process of authenticating other nodes in the network. The authentication process is based on the ability of these other nodes, referred to as unauthenticated nodes, to observe and report on changes in a physical phenomenon. In the context of the BMS, this physical phenomenon is typically the current or voltage of the battery pack.

The trusted node may be configured to initiate the authentication process by causing one or more battery cells of the battery pack to alter a current or a voltage. This alteration follows a pattern known to the trusted node. The unauthenticated node, wishing to be authenticated, is instructed by the trusted node to sample the current or voltage of the battery pack at predetermined intervals. The unauthenticated node observes the pattern of alteration in the current or voltage and calculates a value based on this observed pattern (e.g., a voltage value).

The unauthenticated node then sends this calculated value to the trusted node. The trusted node may be configured to independently calculate a value based on the known pattern of alteration in the current or voltage. The trusted node may be configured to compare the value received from the unauthenticated node with its independently calculated value. Based on the comparison, e.g., if these two values match within a predetermined tolerance, the trusted node can authenticate the unauthenticated node as a member of the BMS.

These authentication techniques can be used to prevent a malicious node that is within range of a network from interfering with the network. The malicious node may be external to the system (e.g., outside of a vehicle or machine) and therefore incapable of measuring the requested system metric. A trusted node can deny authentication to a malicious node that is unable to accurately measure the system metric and uplink the measured metric to the trusted node. The authentication techniques described herein can be used with or without an authentication whitelist or other network security approaches. Authentication without a whitelist is useful in the case of the replacement of a node in which the new node is not listed on the existing whitelist.

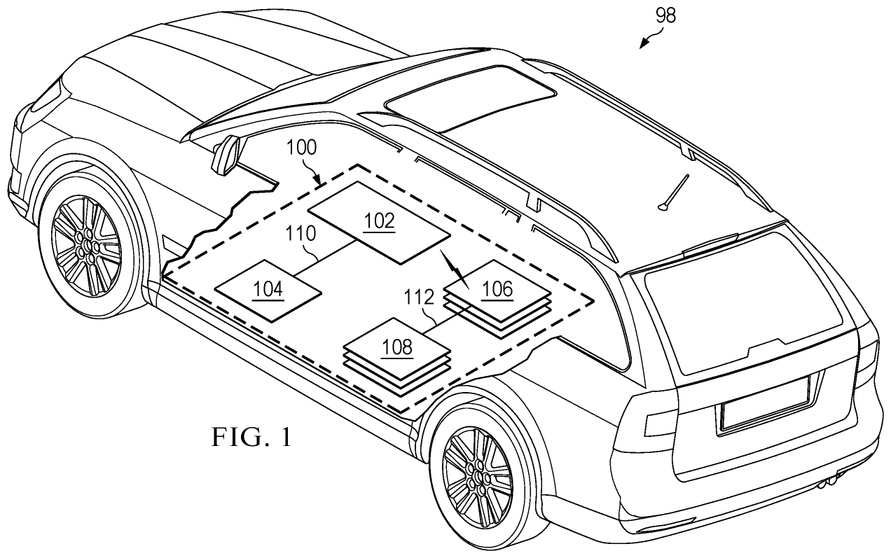

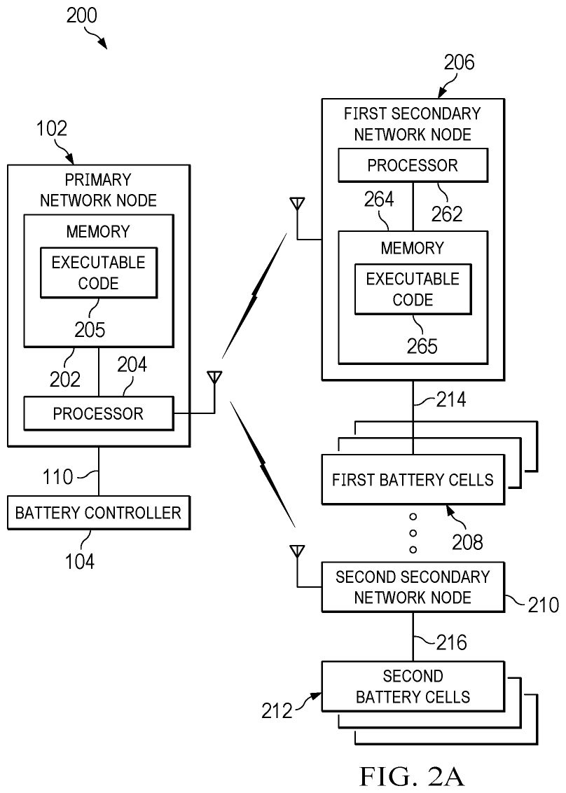

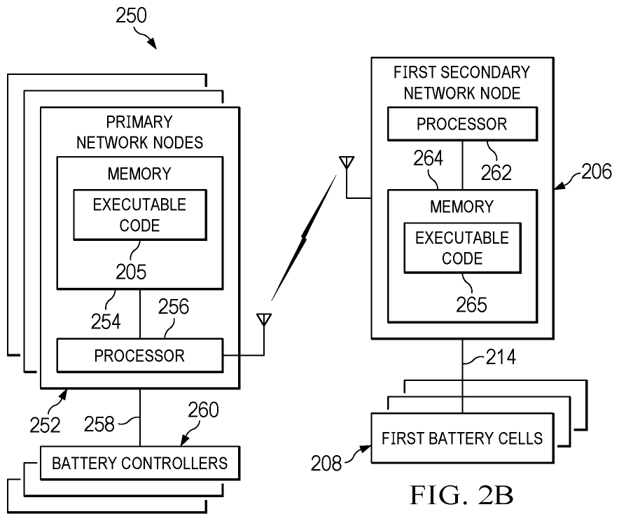

FIGS. 1, 2A and 2B describe example WBMSs which may implement these authentication techniques for unauthenticated nodes. In particular, FIG. 1 is a perspective view of an example system 98, such as an automotive vehicle, that includes a wireless battery management system (WBMS) 100. In some examples, the system 98 is any system that may include a WBMS to supply power to one or more components of the system 98. Although this system is described in the context of an automotive system and a battery management system, the techniques of this disclosure may be implemented in other systems such as home automation, industrial automation, and wireless sensor networks. Such systems may include one or more central nodes and two or more secondary nodes and may or may not be used for monitoring battery cells.

As shown, the WBMS 100 includes a primary network node 102, a battery controller 104, a plurality of secondary network nodes 106, and a plurality of battery cells 108. In an example, the WBMS 100 may include a plurality of primary network nodes. Although this disclosure describes communication techniques primarily in the context of wireless systems, these techniques may also be useful for wired systems (e.g., where the connection between nodes 102 and 106 is wired). The WM and/or WDs in a WBMS may be implemented as a CC2662 and/or a BQ79616 made by Texas Instruments Inc. of Dallas, TX. Additional example details of the CC2662 and BW79616 can be found in the datasheet entitled “CC2662R-Q1 SimpleLink™ Wireless BMS MCU,” revised July 2023, available at https://www.ti.com/product/CC2662R-Q1, and the datasheet entitled “BQ79616-Q1, BQ79614-Q1, BQ79612-Q1 Functional Safety-Compliant Automotive 16S/14S/12S Battery Monitor, Balancer and Integrated Hardware Protector,” revised September 2022, available at https://www.ti.com/product/BQ79616-Q1, each of which is incorporated by reference in its entirety.

In an example, the primary network node 102 is coupled to the battery controller 104 using a first wired connection 110. In an example, the first wired connection 110 between the primary network node 102 and the battery controller 104 is a universal asynchronous receiver/transmitter (UART), inter-integrated circuit (I2C), or the like. The secondary network nodes 106 are wirelessly coupled to the primary network node 102 and coupled to the battery cells 108 using a second wired connection 112.

In an example, the WBMS 100 provides wireless radio frequency (RF) communication between the primary network node 102 and the secondary network nodes 106. In an example, the wireless RF communication uses the license-free 2.4 gigahertz (GHz) industrial, scientific, and medical (ISM) band from 2.4 GHz to 2.483 GHz, which is compliant with BLUETOOTH special interest group (SIG). In examples, the WBMS 100 uses 2 megabits per second (Mbps) BLUETOOTH low energy (BLE) across the physical layer (PHY). The Open Systems Interconnection (OSI) model includes the PHY as a layer used for communicating raw bits over a physical medium. In this case, the PHY is free space, which the WBMS 100 uses to wirelessly communicate between the primary network node 102 and the secondary network nodes 106. In an example, the transmission power of the WBMS 100 is less than or equal to 10 decibel-milliwatts (dBm).

In an example, the wireless RF communication between the primary network node 102 and the secondary network nodes 106 utilizes frequency hopping and time slotted allocations to transmit and receive data across super frames (SFs). A super frame, also referred to as a super frame interval, is a time interval including time and frequency allocations for data exchanges between the primary network node 102 and the secondary network nodes 106, including interframe spacing between these allocations. Frequency hopping includes transmitting RF signals by rapidly changing the transmission frequency among many distinct frequencies occupying a spectral band. In an example, frequency hopping occurs based on a linear shift-back register and a master identification (ID) of the primary network node 102. The linear shift-back register uses linear bit rotation to indicate a pattern of frequencies on which the primary network node 102 and the secondary network nodes 106 will communicate. Time slotted allocations are time slots that are assigned either to the primary network node 102 or one or more of the secondary network nodes 106 for transmitting to either one or more of the secondary network nodes 106 or the primary network node 102. The time slotted allocations occur in a half-duplex mode, as both the primary network node 102 and the secondary network nodes 106 switch between transmit and receive modes according to the temporal moment specified in scan/pairing frames of exchanged data for downlink (DL)/uplink (UL) durations.

In an example, the WBMS 100 uses frequency division multiple access (FDMA) and changes the frequency at which frames are transmitted between the primary network node 102 and the secondary network nodes 106 to increase robustness against interference. In an example, the WBMS 100 uses frequency hopping tables, black listing of frequencies, and configuration channels to mitigate interference with other wireless networks. Frequency hopping occurs on a per super frame (SF) basis, where during the SF, time slotted allocations are used for frame exchange. Black listing is suspending the use of frequency channels that may be susceptible to interference. Configuration channels may be used for scanning, pairing, and negotiating communication between the primary network node 102 and the secondary network nodes 106.

In an example, the wireless RF communication between the primary network node 102 and the secondary network nodes 106 uses 40 channels, where a subset of the 40 channels (e.g., channels 37, 38, and 39) is used for system configuration and the remaining 37 channels are used to exchange data. In an example, a single channel may be used as a configuration channel.

In an example, the WBMS 100 supports periodic and a-periodic data exchanges from the secondary network nodes 106 to the primary network node 102 using wireless RF communication. The primary network node 102 and the secondary network nodes 106 use a common data format structure for both periodic and a-periodic data exchanges. Periodic data exchange occurs based on a repetitive interval, while a-periodic data exchange does not occur based on a repetitive interval. The data format is a description of rules that the data populating a file will follow. Generally, the more thorough the description of the data format, the easier it is for validation rules to be written on both the sending and receiving sides of the WBMS 100.

In an example, the primary network node 102 scans the network to obtain a master ID and discover the secondary network nodes 106. The primary network node 102 scans the network by transmitting a management frame to coordinate medium access, wakeup schedules, and clock synchronization within the secondary network nodes 106. The primary network node 102 also uses the management frame to learn about the secondary network nodes 106 in the network. Initially, the primary network node 102 performs a passive scan to obtain (or check for) a master ID value in use by other nodes and/or devices. The primary network node 102 then selects a master ID that is different from the master IDs used by other nodes and/or devices.

In an example, after the primary network node 102 has selected a master ID, the primary network node 102 transmits a scan request frame in every SF period as long as there are unconnected secondary network nodes 106 from the primary network node 102. In an example, the primary network node 102 is programmed with the total number of the secondary network nodes 106 to be connected to the primary network node 102. After all the secondary network nodes 106 are connected and authenticated, the primary network node 102 will not transmit any more scan requests. The scan request frames include information about the structure of the SF and the frame formatting of the DL and UL slots.

For the primary network node 102 to scan for the secondary network nodes 106, the primary network node 102 enters a scan state. In this state, the primary network node 102 transmits a scan request frame in every SF period. The secondary network nodes 106 reply to the primary network node 102 with a scan response and await a pairing request frame from the primary network node 102. After the secondary network nodes 106 receive the pairing request, the secondary network nodes 106 respond within the same SF in the frequency slot assigned by the primary network node 102. In examples, this exchange occurs in the configuration channels. No data exchanges occur in this state. Additional example details of establishing a communication channel can be found in commonly assigned U.S. patent application Ser. No. 17/233,106, entitled “Wireless Protocol for Battery Management,” filed on Apr. 16, 2021; and U.S. patent application Ser. No. 17/399,793, entitled “WBMS Setup,” filed on Aug. 11, 2021, each of which is incorporated by reference in its entirety.

In an example, transmission cycles or SFs depend on the number of secondary network nodes 106 and/or battery cells 108 in the network. The primary network node 102 determines the SF interval based on the number of secondary network nodes 106. Given a number of secondary network nodes 106, the primary network node 102 estimates the number of DL slots usable to transmit the packets to the secondary network nodes 106. Accordingly, the total number of slots in the communication time interval becomes the following:

Total_slots=nr_of_WD+nr_DL_slots,

where nr_of_WD is the number of secondary network devices and nr_DL_slots is the number of DL slots available to the secondary network devices.

The WBMS 100 manages the battery cells 108 using the primary network node 102, the battery controller 104, and the secondary network nodes 106. The primary network node 102 and the secondary network nodes 106 communicate with each other about the state of the battery cells 108. The primary network node 102 and the secondary network nodes 106 may communicate with each other using various protocol formats. For example, the primary network node 102 and the secondary network nodes 106 use a DL protocol format and a UL protocol format, where each of the DL protocol format and the UL protocol format includes a frame control field to communicate battery management information. When the battery cells 108 notify the secondary network nodes 106 of a condition, the secondary network nodes 106 communicate to the primary network node 102 that the condition is present. The primary network node 102 receives the notification of the condition from the secondary network nodes 106 and alerts the battery controller 104 of the condition. The battery controller 104 determines a proper reaction to the condition and sends an instruction to the primary network node 102. The primary network node 102 transmits the instruction to the secondary network nodes 106. The secondary network nodes 106 receive the instruction to manage the battery cells 108 in response to the condition. The secondary network nodes 106 manage the battery cells 108 in response to the condition.

Although FIG. 1 shows a single primary network node 102 and a single battery controller 104, other example network architectures having multiple primary/main nodes can be used to implement the techniques of this disclosure. Additional example details of network architectures for WBMSs can be found in commonly assigned U.S. patent application Ser. No. 17/823,138, entitled “Multiple Primary Nodes for Wireless Battery Management System Robustness,” filed on Aug. 30, 2022, and U.S. patent application Ser. No. 18/345,636, entitled “Hierarchical Wireless Battery Management System,” filed on Jun. 30, 2023, each of which is incorporated by reference in its entirety.

FIG. 2A illustrates an example WBMS 200. The WBMS 200 is an example of the WBMS 100 described above. As shown, the WBMS 200 includes the primary network node 102, the battery controller 104, a memory 202, a processor 204, a first secondary network node 206, a first plurality of battery cells 208, a second secondary network node 210, and a second plurality of battery cells 212. Additional secondary network nodes 206, 210 may be included, although they are not expressly shown. The primary network node 102 includes the memory 202 and the processor 204 that is configured to execute code 205 stored on the memory 202 to perform one or more of the actions attributed herein to the primary network node 102. In an example, a portion of the memory 202 may be non-transitory and a portion of the memory 202 may be transitory. The secondary network nodes 206, 210 also may include processors and memory. For example, as shown, the secondary network node 206 includes a processor 262 coupled to a memory 264 storing code 265 that is executable by the processor 262 to perform one or more of the actions attributed herein to the secondary network node 206.

The primary network node 102 is coupled to the battery controller 104 using the first wired connection 110 and is wirelessly coupled to each of the secondary network nodes 206, 210. The first secondary network node 206 is coupled to the first plurality of battery cells 208 using a third wired connection 214 and wirelessly coupled to the primary network node 102. The second secondary network node 210 is coupled to the second plurality of battery cells 212 using a fourth wired connection 216 and wirelessly coupled to the primary network node 102. FIG. 2A does not limit the number of secondary network nodes in the WBMS 200; rather, the naming convention indicates that each of the secondary network nodes is coupled to a plurality of battery cells.

In an example, the primary network node 102 is wirelessly coupled to at least eight secondary network nodes 206, 210. In an example, each of the secondary network nodes 206, 210 can be coupled to at least sixteen battery cells using a wired connection. In examples, the WBMS 200 includes one primary network node. In other examples, the WBMS 200 includes multiple primary network nodes.

The WBMS 200 manages the first plurality of battery cells 208 and the second plurality of battery cells 212 using the primary network node 102, the battery controller 104, the memory 202, the processor 204, the first secondary network node 206, and the second secondary network node 210. Instructions in the memory 202 cause the processor 204 to instruct the primary network node 102 to wirelessly communicate with the first secondary network node 206 and the second secondary network node 210 about the state of the first plurality of battery cells 208 and the second plurality of battery cells 212. The primary network node 102 and the secondary network nodes 206, 210 communicate using various protocol formats. For example, the primary network node 102 and the secondary network nodes 206, 210 use a DL protocol format and a UL protocol format, where each of the DL protocol format and the UL protocol format includes a frame control field to communicate battery management information. When the first plurality of battery cells 208 notify the first secondary network node 206 of a condition, the first secondary network node 206 communicates with the primary network node 102 that the condition is present. The primary network node 102 receives the notification of the condition from the first secondary network node 206 and alerts the battery controller 104 of the condition. The battery controller 104 determines a proper reaction to the condition and sends an instruction to the primary network node 102. The primary network node 102 transmits the instruction to the first secondary network node 206. The first secondary network node 206 receives the instruction to manage the first plurality of battery cells 208 in response to the condition of the first plurality of battery cells 208. The first secondary network node 206 manages the first plurality of battery cells 208 in response to the condition. A similar process may apply to the second secondary network node 210 when a condition is present in the second plurality of battery cells 212. FIG. 2B illustrates an example WBMS 250. The WBMS 250 is an example of the WBMS 100 described above. As shown, the WBMS 250 includes the first secondary network node 206, the first plurality of battery cells 208, a plurality of primary network nodes 252, a memory 254, a processor 256, a first wired connection 258, and a plurality of battery controllers 260. The plurality of primary network nodes 252 includes the memory 254 and the processor 256. In an example, a portion of the memory 254 may be non-transitory and a portion of the memory 254 may be transitory. In examples, the memory 254 includes executable code 255 which, when executed by the processor 256, causes the processor 256 to perform the actions attributed herein to the primary network node 252.

The plurality of primary network nodes 252 are coupled to the plurality of battery controllers 260 using the first wired connection 258 and are wirelessly coupled to the secondary network node 206. The first secondary network node 206 is coupled to the first plurality of battery cells 208 using the wired connection 214 and wirelessly coupled to the plurality of primary network nodes 252. As shown in FIG. 2A, the first secondary network node 206 may include a processor and memory (e.g., processor 262 and memory 264). FIG. 2B does not limit the number of secondary network nodes in the WBMS 250. In an example, each of the plurality of primary network nodes 252 is wirelessly coupled to at least eight secondary network nodes. In an example, the first secondary network node 206 can be coupled to at least sixteen battery cells using the fourth wired connection 216.

The WBMS 250 manages the first plurality of battery cells 208 using the plurality of primary network nodes 252, the plurality of battery controllers 260, the memory 254, the processor 256, and the first secondary network node 206. Instructions in the memory 254 cause the processor 256 to instruct the plurality of primary network nodes 252 to wirelessly communicate with the first secondary network node 206 about the state of the first plurality of battery cells 208. The plurality of primary network nodes 252 and the first secondary network node 206 communicate using various protocol formats. For example, the plurality of primary network nodes 252 and the first secondary network node 206 use a DL protocol format and a UL protocol format, where each of the DL protocol format and the UL protocol format includes a frame control field to communicate battery management information. When the first plurality of battery cells 208 notify the first secondary network node 206 of a condition, the first secondary network node 206 communicates with the plurality of primary network nodes 252 that the condition is present. The plurality of primary network nodes 252 receives the notification of the condition from the first secondary network node 206 and alerts the plurality of battery controllers 260 of the condition. The plurality of battery controllers 260 determines a proper reaction to the condition and sends an instruction to the plurality of primary network nodes 252. The plurality of primary network nodes 252 transmits the instruction to the first secondary network node 206. The first secondary network node 206 receives the instruction to manage the first plurality of battery cells 208 in response to the condition of the first plurality of battery cells 208. The first secondary network node 206 manages the first plurality of battery cells 208 in response to the condition.

In an example, the first secondary network node 206 communicates with a first primary network node of the plurality of primary network nodes 252 based on instructions from a master controller (not shown). The first secondary network node 206 can transition communication from the first primary network node to a second primary network node of the plurality of primary network nodes 252. The first primary network node and the second primary network node communicate with each other to coordinate transferring the active connections of the first secondary network node 206 from the first primary network node to the second primary network node. In an example, the first primary network node communicates with the first secondary network node 206 and the second primary network node monitors a status of the first primary network node. The status can indicate whether the first primary network node has power and is operating within normal operating conditions. The first primary network node provides a clock signal to the second primary network node to synchronize communication. The first primary network node and the second primary network node select different frequencies to communicate with the first secondary network node 206. Selecting different frequencies allows the plurality of primary network nodes 252 to minimize interference when communicating to the first secondary network node 206. For example, if the first primary network node were to lose power, or if the status of the first primary network node were to fall out of normal operating conditions, then the second primary network node can connect to the first secondary network node 206 to supplement communication until the first primary network node can operate normally again.

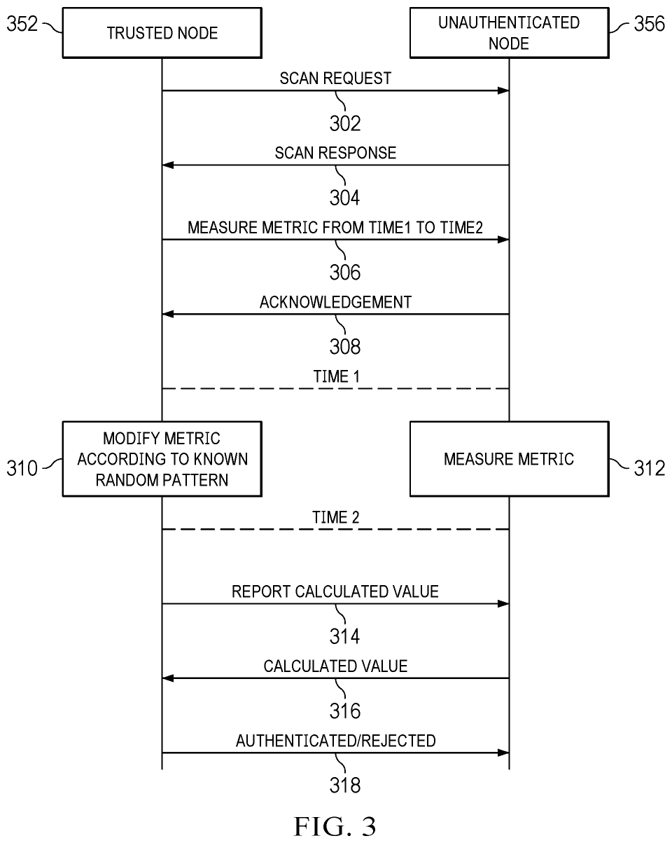

FIG. 3 is a sequence diagram showing the process of authenticating a node in a WBMS, such as WBMS 100, WBMS 200, or WBMS 250. This process involves a series of steps initiated by a trusted node, such as trusted node 352, and involves interaction with an unauthenticated node, such as unauthenticated node 356, wishing to be authenticated. In various examples, trusted node 352 is either a master node of the WMBS or a node that is verified by the master node of the WBMS. For star topology, the trusted node 352 can be the Master node or one Secondary node. For mesh topology, the trusted node 352 can be one or more of the peer nodes. With respect to WBMS 100 (FIG. 1) trusted node 352 may be implemented within a variety of system components, such as, but not limited to primary network node 102, one or more of secondary network nodes 106, and battery controller 104. If the master node and trusted node 352 are different nodes, trusted node 352 can begin the process by forming a network with the master node. After this network is formed, the master node can communicate with trusted node 352 and instruct trusted node 352 to charge or discharge one or more battery cells.

The unauthenticated node 356 is a node that is not known to the trusted node 352 or a node that is not authenticated by the trusted node 352. In these examples, there may not be a whitelist of nodes. The techniques of FIG. 3 illustrate unauthenticated node 356 as a member of the same battery pack (cluster) without the need for an explicit whitelist, although some implementations of the techniques of this disclosure may still use an explicit whitelist. Such techniques may be useful to initially provision a battery pack and at other times during the operation of the battery pack. In addition, nodes may be authenticated during maintenance or repair of the battery pack, e.g., during replacement of individual battery cells. With respect to WBMS 100 (FIG. 1) unauthenticated node 356 may be one of secondary network nodes 106.

Authentication is done on a per-node basis. The techniques of FIG. 3 illustrate authentication for a single unauthenticated node 356. The techniques of FIG. 3 begin with trusted node 352 sending scan requests 302 on predetermined config channels. Wireless devices that wish to join the cluster listen for the scan requests 302 on one or more of the config channels. A member or non-member wireless device, such as unauthenticated node 356 that receives a scan request sends a scan response 304, by way of a scan response frame, to be authenticated by the trusted node 352.

Upon sending out the scan requests, the trusted node 352 is configured to receive scan responses from other nodes in the network that wish to be authenticated. In this context, the unauthenticated node 356 sends a scan response, denoted as scan response 304, to the trusted node 352. The scan response 304 serves as an indication of the unauthenticated node 356's desire to be authenticated and join the network.

Unauthenticated node 356 is synchronized with trusted node 352 following the scan response 304. After the scan response 304, unauthenticated node 356 receives a sample instruction 306 from trusted node 352 to monitor a physical phenomenon. For example, unauthenticated node 356 may receive a sample instruction 306 from trusted node 352 to sample the current/voltage between two given timestamps at a given sampling frequency. In response, unauthenticated node 356 sends an acknowledgement 308 to the trusted node 352.

Trusted node 352 then modifies or manipulates a physical metric, such as charging and discharging the battery pack in a pattern known only to trusted node 352, such as a random pattern known only to the master node and/or trusted node 352 (modify metric 310). In other examples, the pattern could be predetermined or dynamically generated based on various factors such as the state of the battery cells, the network conditions, or other operational parameters of the WBMS. Unauthenticated node 356 measures the metric, e.g., by sampling the current/voltage between two given timestamps at a given sampling frequency (measure metric 312). Both of the two timestamps may be after the trusted node 352 modifies the metric at step 310, so that unauthenticated node 356 measures the modified metric, rather than the unmodified metric.

After the period between the two timestamps, unauthenticated node 356 receives a request 314 from trusted node 352 to report a value based on the observed physical parameters. In response, unauthenticated node 356 sends/uplinks a calculated value 316 based on the physical parameters observed during the predetermined interval to the trusted node 352. In some examples, unauthenticated node 356 may send the calculated value 316 to trusted node 352 without receiving the request 314. The calculation could involve various mathematical or statistical operations such as averaging, integration, or hashing, and could also consider the timestamps at which the current or voltage was sampled.

The calculated value may involve encryption or other proprietary calculations unique to the WBMS and authorized components for the WBMS. In this manner, the disclosed techniques allow the battery pack manufacturer to control installation and repairs of battery cells within the battery pack. For example, the techniques may be utilized to block installation of unapproved aftermarket battery cells, prevent switching of OEM battery cells between vehicles, and or prevent repairs or replacement of the battery cells by unauthorized individuals. For example, the encryption or other proprietary calculations may be specific to each battery pack and/or vehicle. In some examples, the authentication techniques disclosed herein may require configuring the battery cells with the encryption or other proprietary calculation for that battery pack and/or vehicle. In other examples, a more general encryption or other proprietary calculation may be used such that battery cells approved by the OEM are suitable for installation without configuration specific to the vehicle or battery pack.

Trusted node 352 receives the calculated value 316 from unauthenticated node 356 and calculates the value independently based on the pattern. The trusted node 352 then compares the value received from the unauthenticated node 356 with its independently calculated value. This comparison could involve determining if the two values match within a predetermined tolerance. If the value received from the unauthenticated node 356 matches the independently calculated value within the predetermined tolerance, the trusted node 352 authenticates the unauthenticated node 356 as a member of the WBMS, denoted as authentication 318. This authentication process ensures that the authenticated node is physically connected to the battery pack.

In some cases, if the value received from the unauthenticated node 356 does not match the independently calculated value within the predetermined tolerance, the trusted node 352 may optionally reject the unauthenticated node 356. This ensures that nodes that are unable to accurately observe and report on changes in the current or voltage of the battery pack, e.g., not physically connected to the battery pack, are not authenticated, thereby maintaining the integrity and security of the WBMS.

As just an example, trusted node 352 can cause one or more battery cells to be discharged before unauthenticated node 356 measures the battery voltage. Trusted node 352 then calculates an expected decrease in the battery voltage after discharging the one or more battery cells. Trusted node 352 can compare the expected decrease in voltage with the value received from unauthenticated node 356 and determine whether to authenticate or reject the unauthenticated node 356 based on the comparison. In this example, if unauthenticated node 356 reports a value indicating an increase in the battery voltage, in contrast to the expected decrease in the battery voltage, the trusted node 352 can reject the unauthenticated node 356 from joining the WBMS.

The techniques of FIG. 3 are described in the context of trusted node 352 and unauthenticated node 356. In some examples, a master node in the network may perform some or all of the functionality attributed to trusted node 352 in FIG. 3. For example, the master node may provide the timestamps to trusted node 352 for the sample instruction 306. As another example, the master node can compare the measured metric received from unauthenticated node 356 to the expected value.

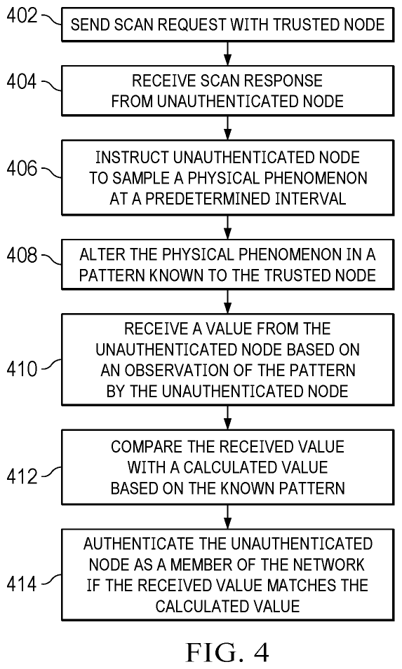

FIG. 4 is a flow diagram of a method for authenticating a node for a WBMS, such as any of WBMS 100, WBMS 200, WBMS 250, or other WBMS according to various examples. For clarity, the techniques of FIG. 4 are described with respect to FIG. 3, including the trusted node 352 and the unauthenticated node 356.

First, the trusted node 352 sends out scan requests 302 on predetermined channels (step 402). The trusted node 352 receives a scan response 304 from the unauthenticated node 356 wishing to be authenticated (step 404). The trusted node 352 may receive additional scan responses from other nodes wishing to be authenticated.

After the scan response 304, trusted node 352 send a sample instruction 306 to sample the current/voltage at a predetermined interval, such as between two given timestamps at a given sampling frequency (step 406). In response, trusted node 352 receives sends an acknowledgement 308 from unauthenticated node 356.

The trusted node 352 then modifies a physical metric, such as by charging and/or discharging the battery pack, in a pattern known only to trusted node 352, such as a random pattern (step 408). Following the modification of the physical metric, the trusted node 352 receives a value corresponding to the physical metric during the predetermined interval from the unauthenticated node 356 (step 410). The trusted node 352 may send a message to the unauthenticated node 356 to request that the unauthenticated node 356 send the value to the trusted node 352.

The trusted node 352 independently calculates a value based on the corresponding to the physical metric during the predetermined interval and compares its calculated value with the value corresponding to the physical metric during the predetermined interval from the unauthenticated node 356 (step 412). The values may be calculated based on the known pattern or another property of the physical metric during the predetermined interval.

The trusted node 352 authenticates the unauthenticated node 356 as a member of the network based on comparing the first value with the second value if the value received from the unauthenticated node 356 indicates the unauthenticated node 356 measured the physical metric during the predetermined interval (step 414). The trusted node 352 optionally rejects the unauthenticated node 356 as if the first value does not match the second value within a predetermined tolerance.

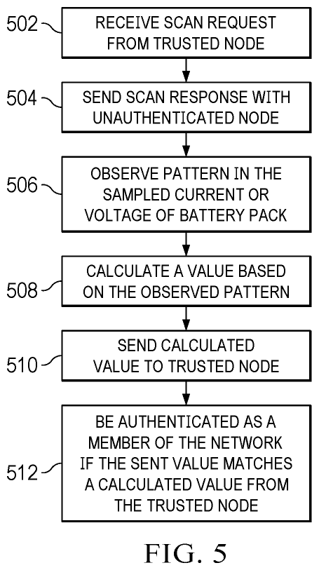

FIG. 5 is a flow diagram of a method by a node to be authenticated by a WBMS, such as any of WBMS 100, WBMS 200, WBMS 250, or other WBMS according to various examples. For clarity, the techniques of FIG. 5 are described with respect to FIG. 3, including the trusted node 352 and the unauthenticated node 356.

First, the unauthenticated node 356 receives a wireless scan request 302 from the trusted node 352 on predetermined channels (step 502). The unauthenticated node 356 sends a wireless scan response 304 to the trusted node 352 (step 504). After the scan response 304, unauthenticated node 356 receives a sample instruction 306 from trusted node 352 to sample the current/voltage between two given timestamps at a given sampling frequency. In response, unauthenticated node 356 sends an acknowledgement 308 to the trusted node 352. Unauthenticated node 356 measures the metric by sampling the current/voltage between two given timestamps at a given sampling frequency and observes a pattern (step 506).

Next, the unauthenticated node 356 calculates a value based on the sampled current or the sampled voltage (step 508). The unauthenticated node 356 sends the calculated value to the trusted node 352 (step 510).

In response to sending the calculated value to the trusted node 352, the unauthenticated node 356 is authenticated as a member of the WBMS (step 512).

The term “couple” is used in the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Unless otherwise stated, “about,” “approximately,” or “substantially” preceding a value means+/−10 percent of the stated value. Modifications are possible in the described examples, and other examples are possible within the scope of the claims.

What is claimed is:

1. A battery management system (BMS), comprising:
a battery pack including multiple battery cells; and
a first node configured to:
cause one or more battery cells of the battery pack to alter a current or a voltage;
receive a first value from a second node;
compare the first value with a second value calculated based on the altered current or the altered voltage; and
authenticate the second node as a member of the BMS based on comparing the first value with the second value.

2. The BMS of claim 1, wherein the first node is further configured to optionally reject the second node based on comparing the first value with the second value.

3. The BMS of claim 1, wherein the first node is further configured to:
initiate a scanning process by wirelessly sending out scan requests on predetermined channels;
receive a scan response from the second node wishing to be authenticated; and
instruct the second node to sample the current or the voltage of the battery pack at a predetermined interval.

4. The BMS of claim 3, wherein instructing the second node to sample the current or the voltage at the predetermined interval includes instructing the second node to sample a physical phenomenon at predetermined timestamps at a given sampling frequency.

5. The BMS of claim 1, wherein causing the one or more battery cells of the battery pack to alter the current or the voltage includes causing the one or more battery cells of the battery pack to alter the current or the voltage includes in a pattern known to the first node.

6. The BMS of claim 1, wherein authenticating the second node as a member of the BMS based on comparing the first value with the second value includes determining if the first value matches the second value within a predetermined tolerance.

7. The BMS of claim 1, wherein the first node is a trusted node, and wherein the second node is an unauthenticated node.

8. The BMS of claim 1, wherein the second node is a Master node or a Secondary node in a star topology network.

9. The BMS of claim 1, wherein the second node is one or more peer nodes in a mesh topology network.

10. The BMS of claim 1, wherein a pattern of altering the current or the voltage is random.

11. The BMS of claim 1, wherein the second node is authenticated without an explicit whitelist.

12. The BMS of claim 1, wherein the second node is authenticated on a per-node basis.

13. A method for authenticating wireless nodes in a network by a first node in the network, the method comprising:
altering a physical phenomenon in a pattern known to the first node;
receiving a first value from a second node;
comparing the first value with a second value calculated based on the known pattern; and
authenticating the second node as a member of the network based on comparing the first value with the second value.

14. The method of claim 13, further comprising rejecting the second node as if the first value does not match the second value within a predetermined tolerance.

15. The method of claim 13, further comprising:
sending out, with the first node on the network, scan requests on predetermined channels;
receiving a scan response from the second node wishing to be authenticated; and
instructing the second node to sample the physical phenomenon at a predetermined interval.

16. The method of claim 13, wherein the physical phenomenon is a current or a voltage of a battery pack.

17. The method of claim 13, wherein the first value is calculated based on the pattern.

18. A method for a second node to be authenticated in a Wireless Battery Management System (WBMS), the method comprising:
sampling a current or a voltage of a battery pack;
calculating a first value based on the sampled current or the sampled voltage;
sending the first value to a first node; and
in response to sending the first value to the first node, receiving an indication of authentication as a member of the WBMS.

19. The method of claim 18, further comprising:
receiving a wireless scan request from the first node of the WBMS on predetermined channels; and
sending a wireless scan response to the first node.

20. The method of claim 19, wherein the sampled current or the sampled voltage is a random pattern.
